(19) United States
(12) Patent Application Publication
(10) Pub. No.: US 2024/0411132 A1
(43) Pub. Date: Dec. 12, 2024

(54) EFFICIENT GHOST-LESS REFLECTOR EXPLOITING P-POLARIZATION

(71) Applicant: Spectralics Ltd., Tel aviv (IL)

(72) Inventors: Yuval KASHTER, Tel aviv (IL); Eran FALEK, Tel aviv (IL); Ran Abraham BAR-YOSEF, Tel aviv (IL)

(73) Assignee: Spectralics Ltd., Tel aviv (IL)

(21) Appl. No.: 18/810,604

(22) Filed: Aug. 21, 2024

Related U.S. Application Data
(63) Continuation of application No. PCT/IL2023/050189, filed on Feb. 23, 2023.

(30) Foreign Application Priority Data
Feb. 23, 2022 (GB) 2202489.7

(51) Int. Cl. G02B 27/01; B60K 35/23; G02B 27/00; G02B 27/28

(52) U.S. Cl. CPC G02B 27/0101; G02B 27/0018; G02B 27/286; B60K 35/23; B60K 2360/25; G02B 2027/012

(57) ABSTRACT

A layered structure for manipulating optical polarization for a head-up display application is provided herein. The layered structure includes: a Picture Generating Unit “PGU”, the structure adapted to receive polarized light oriented along a Transverse Magnetic “TM” polarization direction, from said PGU, said structure comprising: a first layer comprising a plano-convex lens, wherein the angle between the incidence angle and the optical axis of the plano-convex lens satisfies a Brewster angle; a first polarization manipulating layer adjoining said first layer and adapted to transform the polarization state of said polarized light; an optical partial reflective filter that is designed according to the polarization and reflectivity requirements; and a plano-concave lens, conjugated to the first plano-convex lens.

### CROSS REFERENCE TO RELATED APPLICATION

This application is a Continuation application of PCT Application No. PCT/IL2023/050189 filed Feb. 23, 2023, which claims priority from GB Patent Application No. 2202489.7 filed Feb. 23, 2022, which is incorporated herein by reference in its entirety.

### BACKGROUND OF THE INVENTION

### 1. Technical Field

The present invention relates to the field of automotive windscreen modifications for utilizing optical polarization as part of a head-up display (HUD) in order to reduce or substantially eliminate multiple reflections, viewing problems with sunglasses and imaging glare through the windscreen.

### 2. Background

In recent years there has been a dramatic growth in the requirement for windscreen-based HUDs (i.e., the windscreen itself is employed as an optical combiner). Additionally, the ambition to enhance the optical performance (in terms of field of view, head motion box, etc.) creates a big challenge, due to the requirement to implement a giant lens that can be integrated into the windscreen without affecting the see-through channel.

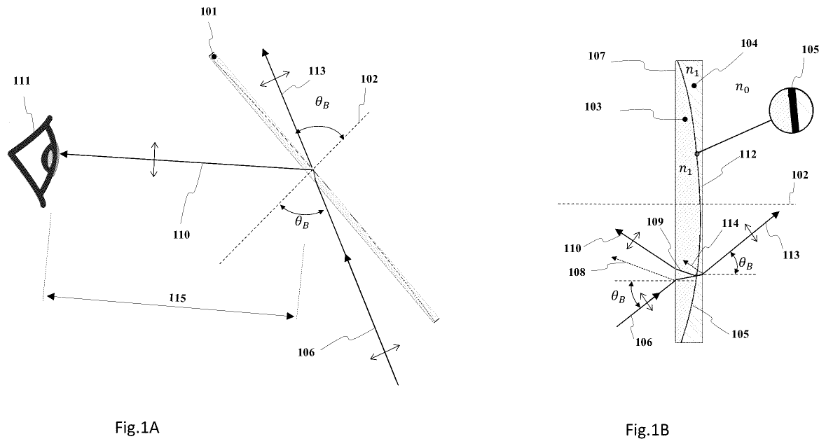

The doublet-like element 101, illustrated in FIG. 1A, describes a Mangin mirror with a central optical axis 102. The element includes two lenses with identical refractive indexes n1; a Plano-convex 103 and a Plano-concave 104 lens (with an identical curvature) are bonded to each other with a partially reflective medium 105 in between. The intermediate partially reflective medium can be implemented by a single layer with different materials (e.g., Titanium Oxide TiO2) or by an airgap between the layers. Furthermore, a partially reflective filter can be deposited and reflect some of the light according to a specific filter design. The filter may be a notch filter for a specific wavelength (or several wavelengths), a uniform partially reflective coating, etc. An incident light 106 is polarized in a Transverse Magnetic (TM) direction, also known as “p-polarization”, meets a planar surface 107 (named the inner surface), where the incident angle is close to the Brewster angle (represented by θ_{B}). By doing so, a commonly used technique to eliminate ghost images is implemented, since, under those circumstances, the portion of light 108 that is reflected from the inner surface 107 is negligible. Therefore, most of the energy penetrates to the inner surface 107 and meets the intermediate concave boundary layer, on which the partially reflective medium 105 is created. From this surface, a portion of the light 109 is reflected back, where it is modulated by the concave surface that may be a spherical surface, an aspherical surface (with rotational symmetry) or a free-form surface. Next, the reflected light 109 meets once again the inner surface 107 and is refracted according to Snell's law. The remaining modulated light 110 is traced to a plane, on which (in many cases) a detector or the eye's retina 111 is located. Since we are dealing with a large eye relief distance 115 (e.g., 750 mm in a car) the surface curvature 105 is relatively moderate (i.e., the radius of curvature is large or polynomial coefficients are relatively small), the refracted light will be close to the Brewster angle, and therefore, since the light is p polarized, the secondary reflection at the inner surface 107 will be minor. The light that transmits through the partially reflective intermediate medium 105 meets the outer surface 112 and is refracted outside (denoted by light 113) according to Snell's law; in this case the resultant angle will be the same as the incident angle, which is in this case the Brewster angle θ_{B}. Consequently, the portion of the light 114 that might be reflected, creating a secondary image (i.e., a ghost image), is negligible due to the fact that it is p polarized and oriented according to the Brewster angle.

The Mangin mirror, in the above-mentioned form, provides a natural see-through (unaffected scenery) whilst providing optical power to the reflected light (due to the existence of the concave intermediate partially reflective surface 105). Therefore, it is commonly employed as a combiner in Head-Up Display (HUD) systems; as it enables the expansion of the system's Numerical Aperture (NA), and therefore, supporting the long eye relief distance 115 (i.e., the distance between the exit pupil and the last optical component). Consequently, the Mangin mirror enhances the optical performance of the HUD system (e.g., expanded field of display, expanded exit pupil, and image distance at infinity).

In most HUD applications, optical artifacts at the see-through channel (such as distortions, scattered light, ghost images, and polarization effects) are unacceptable. Furthermore, the requirement to provide an unaffected scenery will be obtained at the expense of the optical performance of the system, in particular, at the expense of the contrast in daytime. The amount of attenuation of the transmitted light is limited (e.g., according to some OEMs related to automotive it should be less than 20-25%), and therefore, the maximal reflectivity that could be implemented in the partially reflective medium is limited. On the other hand, to allow the observer to perceive the image, the contrast between the projected image and the background should fulfill the customer's specifications (e.g., 1.4 is a well-known contrast ratio that may be required in different background conditions). In other words, the reflectivity percentage at the partially reflective intermediate medium 105 cannot be extremely high but should be sufficient for the contrast requirements. To this end, the reflectivity efficiency for p-polarization between the layers becomes a crucial factor.

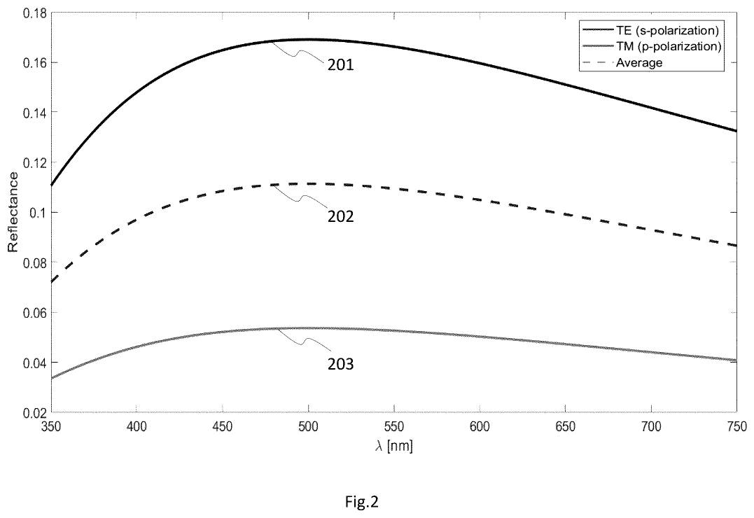

In FIG. 2 an example reflectance graph of a single thin layer of Titanium Oxide (TiO2), located between two glass substrates, is presented. In order to fulfill the Brewster angle for n1=1.5, the incident angle should be 57°; the thickness of the TiO2 layer is set to be a quarter wavelength (for λ=500 nm) to achieve maximum reflection. According to FIG. 2, the reflectance efficiency for 500 nm is 17% for transverse electric “TE” polarization 201, and 5.3% for TM 203. Consequently, the average reflectance 202 of the single layer is 11% at 500 nm. To improve the uniformity of the filter along the visible spectral range, whilst controlling the spectral curves for TE and TM polarizations, a multi-layered optical filter can be designed.

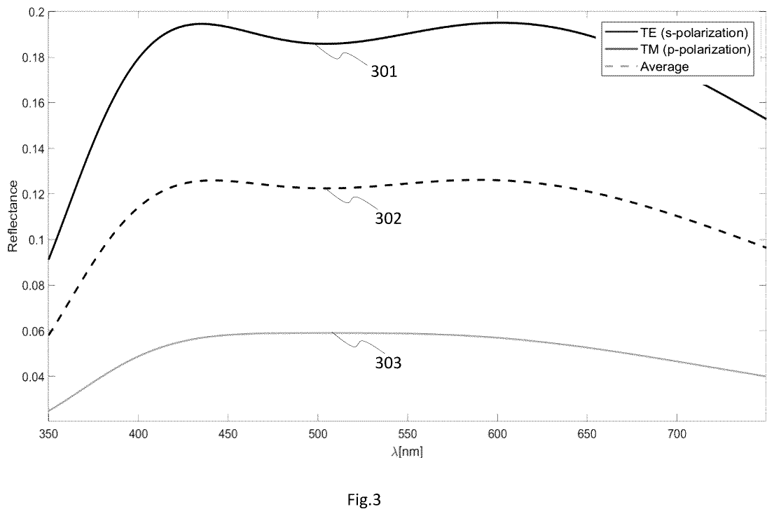

In FIG. 3 an example for an optical filter, consisting of five layers, presents relatively uniform curves for TE 301 and TM 303 with an average reflectance 302 of 12% along the visible range.

In summary, according to the above-mentioned filter designs an average reflectance 302 of 11-12% is obtained. However, due to the existence of an incident TM light, the effective reflectance efficiency from the surface (i.e., the curved surface) is only 5-6%. In other words, the response to TE is relatively high on the one hand, but it is not being used to reflect the incident light. In addition, it provides a significant contribution to the average reflectance.

### The Demagnified Secondary Image Problem

As mentioned above, the curved surface at the optical element modulates the incident light that is traced from the observer's direction, and enhances the optical performance of the HUD system. However, in addition to the required modulation, an additional parasitic modulation also occurs to the light that is traced from the other direction (i.e., light that originates in the outside scenery).

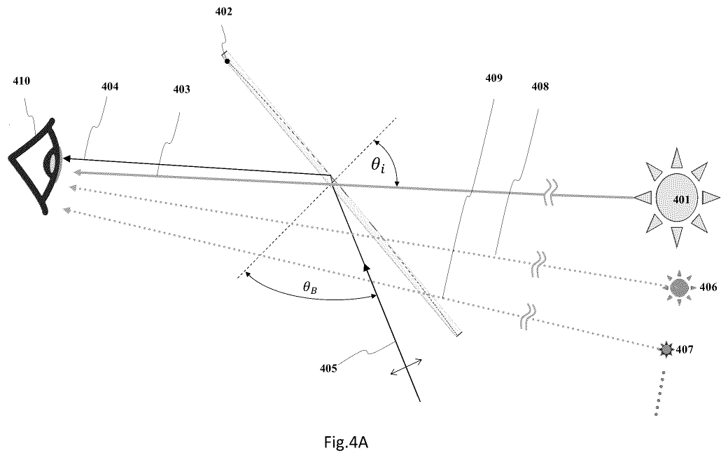

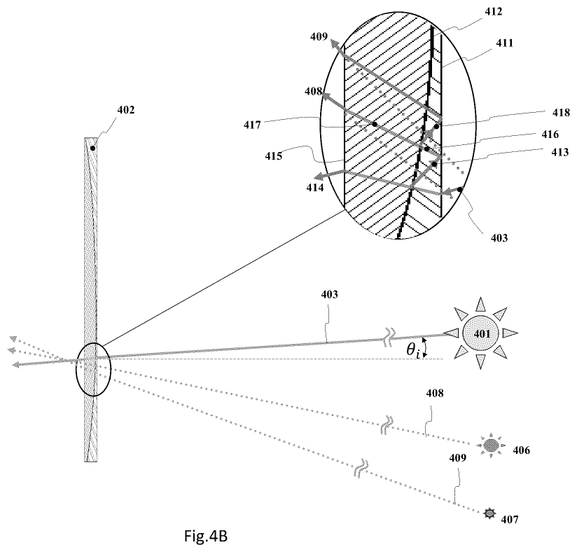

Consequently, stray light originated from objects that emit or reflect radiation with a relatively strong amount of brightness (for example, the sun or bright lamps), may create ghost images that are demagnified by the convex side of the curved surface. The ghost images may be traced to the exit pupil and perceived by the observer. In FIG. 4A the strong illumination source is represented by the sun 401. Due to the existence of the Mangin based element 402, besides the primary rays 403 and 404, originating from the sun 401 and the incident light from a displaying unit 405 [the Picture Generating Unit (PGU)], two corresponding secondary virtual images 406 and 407 are also created by the stray light (represented by 408 and 409, respectively). The stray light 408 and 409 may impinge on the observer 410, affecting his visual experience (e.g., visual artifacts, unexpected images, and glare).

To explain the existence of the demagnified ghost images, a detailed ray-tracing is illustrated in FIG. 4B. The primary ray 403, which originates from the sun 401, meets the outer surface 411 of the optical element 402. Most of the light penetrates to the Mangin based optical combiner 402 and meets the partially reflective intermediate medium 412, on its convex side. Part of the ray transfers through the medium 412, and a portion of the light 413 is reflected back. The amount of light that will be transferred through the medium or reflected back is dependent on the reflectivity efficiency (for example 12% will be reflected back in a case where the filter in FIG. 3 is used) at the incidence angle. Finally, according to Snell's law, a portion of the light 414 that is transferred through the medium 412 will be refracted by the inner glass-air interface 415, The refracted ray 414 might be acquired by the observer and will be manifested as a primary sun's image 401. In addition, a portion of the incident light 413 will be reflected from the convex intermediate surface 412 (on which the above-mentioned partially reflective medium exists). As a result, the light will be modulated by a diverging optical element (i.e., an element with negative optical power). From the reflected (and modulated) ray 413, a portion of the light 416 will be reflected from the outer air-glass interface 411 and will meet the intermediate medium 412 once more. Next, similarly to the primary ray tracing 403, portion of light 417 will be transmitted through the intermediate medium 4112 and will be refracted to the direction of the observer 410 according to Snell's law. The refracted ray 408 may be manifested as the first demnagnified secondary sun's image 406. The remaining energy that is reflected by the intermediate medium 412 will meet once again the outer air-glass interface 411, and again a portion of the light will be reflected, directed to the intermediate medium 412. Similarly, from ray 418, a portion of the light will be reflected on the outer surface 411, transmitted through the intermediate medium 412, and will be refracted by the inner surface 415. This ray 409 will be manifested as the tertiary sun's image 407. Theoretically, an infinite number of secondary images (also named ghost images) exist. However, their light intensity is negligible due to the multiple reflections and refractions, and therefore, most of these images are unperceivable. In addition, not all of the secondary images reach the observer's eye 410.

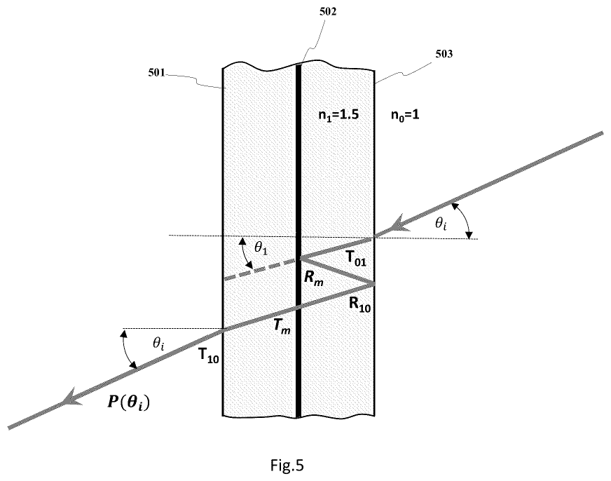

To estimate the relative portion of the light that creates the secondary sun's image, quantification of the power was performed by a numerical simulation (see FIG. 5). The simulation is based on the well-known Fresnel equations that provide an analytical expression for the light's properties that meets a boundary layer between two different materials, with respect to its TE and TM components.

Assuming an approximated planar surface (i.e., the inner surface 501, the intermediate medium 502, and the outer surface 503 could be considered as planar surfaces, locally) the reflection coefficients for TE and for TM in each ijₜₕ boundary layer (between ni and nj) can be expressed as follows:

$${r}_{{TE}_{ij}} = \frac{\vert {E}_{r} \vert}{\vert {E}_{i} \vert} = \frac{{n}_{i} cos ( {θ}_{i} ) - {n}_{j} cos ( {θ}_{j} )}{{n}_{i} cos ( {θ}_{i} ) + {n}_{j} cos ( {θ}_{j} )} , \\ {r}_{{TM}_{ij}} = \frac{\vert {E}_{r}}{\vert {E}_{i} \vert} = \frac{{n}_{j} cos ( {θ}_{i} ) - {n}_{i} cos ( {θ}_{j} )}{{n}_{j} cos ( {θ}_{i} ) + {n}_{i} cos ( {θ}_{j} )} .$$

where, ni and nj represent two refractive indices, θᵢ is the incidence angle of the incoming ray and

$${θ}_{j} = a sin ( \frac{{n}_{i}}{{n}_{j}} sin ( {θ}_{i} ) )$$

is derived from Snell's law.

Additionally, the refractive indices of the media are approximated to non-dispersive materials (i.e., n1 and n2 are constants) and their absorption is also negligible. The mathematical expression of the powers of the reflections R and transmission T in each ijₜₕ boundary layer (along the TE and TM polarization directions) are given as follows:

$${R}_{{TE}_{ij}} = {\vert {r}_{{TE}_{ij}} \vert}^{2} , {R}_{{TM}_{ij}} = {\vert {r}_{{TM}_{ij}} \vert}^{2} , {T}_{{TE}_{ij}} = 1 - {\vert {r}_{{TE}_{ij}} \vert}^{2} , and {T}_{{TM}_{ij}} = 1 - {\vert {r}_{{TM}_{ij}} \vert}^{2}$$

According to FIG. 5, to estimate the relative amount of power of the secondary image (the first ghost image), the coefficients should be multiplied as follows:

$${P}_{TE / TM} ( {θ}_{i} ) = {{T}_{TE / TM} ( {θ}_{i} )}_{01} \cdot {R}_{{m}_{TE / TM}} \cdot {{R}_{TE / TM} ( {θ}_{1} )}_{10} \cdot ( 1 - {R}_{{m}_{TE / TM}} ) \cdot {{T}_{TE / TM} ( {θ}_{1} )}_{10}$$

T₀₁(θᵢ)_{TE/TM} is the portion of light that transmits through the outer layer 503, with respect to the incident angle θᵢ.

Rₘ_{_{TE/TM}} is the portion of light that is reflected by the partially reflective intermediate medium 502.

R₀₁(θ₁)_{TE/TM} is the portion of light that is reflected by the outer layer 503, with respect to incident angle θ₁.

Tₘ_{_{TE/TM}} is the portion of light that transmits through the partially reflective intermediate medium 502.

T₁₀(θ₁)_{TE/TM} is the portion of light that transmits through the outer layer 503, with respect to the incident angle θ₁.

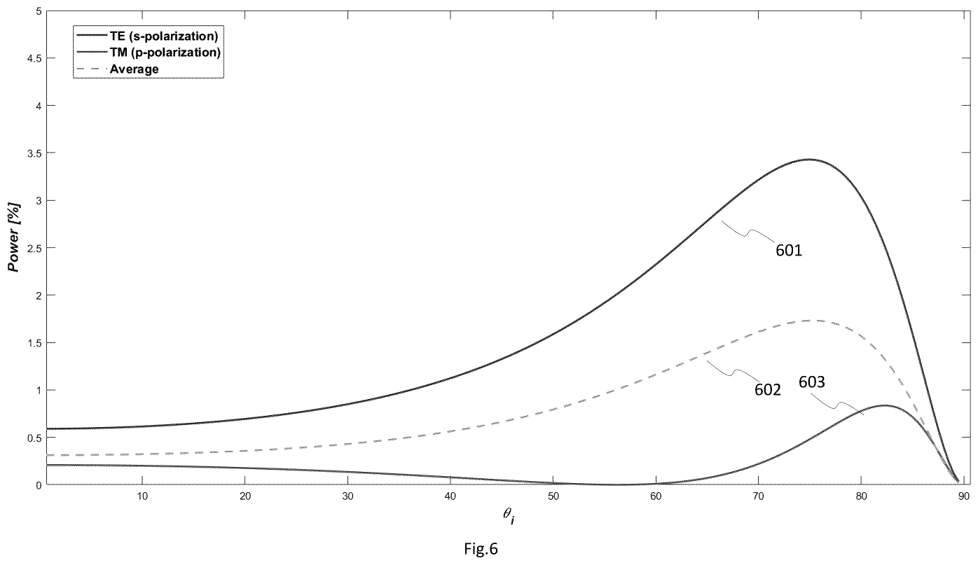

The three curves (presented in FIG. 6) represent the amount of power that exists in the first ghost image along with the TE and TM polarizations 601 and 603 and the average 602 between them, versus the incident angle θᵢ in the range 0-90. The intermediate partially reflective medium, in this case, is the filter represented in FIG. 3. Thus, the reflectivity/transmission here is constant for all the range of angles, where Rₘ_{_{TE}}=0.2 and Rₘ_{_{TM}}=0.06.

As long as the observer is not wearing polarized sunglasses, the amount of light being perceived is the average (represented by the dashed line). According to FIG. 6, the maximal amount of power (relative to the total power of the incident ray) is 1.5%. Moreover, at most angles, the amount of power is more than 0.5%. Consequently, according to the current optical design, the observer will be able to perceive ghost images of strong illumination sources that are directed in large angles relative to the normal. For example, a tilted combiner in a car at sunset may perceive a relatively significant secondary image. Nevertheless, the amount of effective reflectance that is used for the incident light (from the PG U) is only 6%, since the light emitted from the PGU is T M polarized (as discussed above).

For all of the reasons above, there is a requirement for an efficient optical filter for TM polarization which can be used in HUDs.

### The Magnified Ghost Image Problem

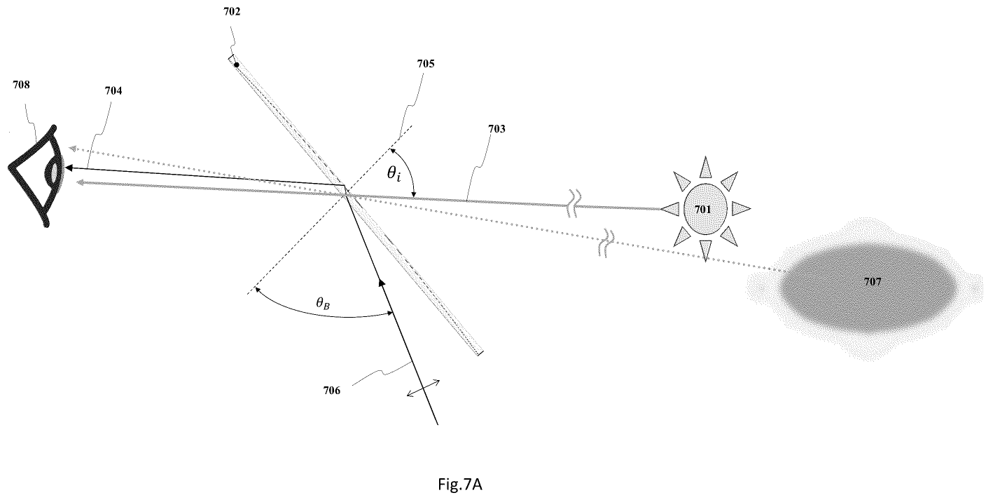

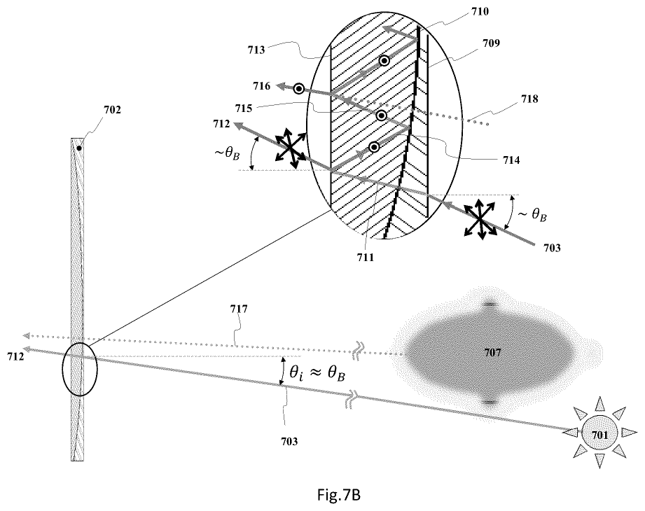

In addition to the above mentioned demagnified secondary images problem, an additional blurry magnified ghost image might be created due to the concave side of the Mangin based element. Unlike the above mentioned demagnified secondary image, the magnified ghost image is created only in a specific location of the source, close to the location where the observer receives the image from the PGU. In FIGS. 7A and 7B the optical scheme and the physical conditions are completely identical to those described in FIG. 4. The conditions that create the magnified ghost image will occur in a case where a strong illumination source 701 (is manifested in the form of a sun) is located in front of the Mangin based element 702, where its primary ray 703 is nearly parallel to primary ray 704 that is reflected by the Mangin 702 partially reflective surface and is originated in the PGU. In other words, the incident angle θi (between the incident angle originated in the sun 703 and the normal incident 705) is close to the incident angle between the primary incident ray 706 originated in the PGU and the normal incident 705. As a result, according to what has been described before, θi is nearly the Brewster angle (θi≈θB). Unlike the demagnified sharp secondary image, the magnified ghost image 707 is blurred, distorted (mainly due to unequal stretches along the vertical and horizontal axes resulted by two different magnification along the horizontal and the vertical directions caused by the off-axis position of the Mangin mirror), Additionally, the ghost magnified image varies along the location and distance of the observer's eye 708. In some use-cases (in particular in cars' HUDs) the magnified ghost image might blind the observer, especially in low ambient light conditions. To explain the existence of the magnified ghost image, a detailed ray-tracing scheme is illustrated in FIG. 7B. In similar to what has been described in the case of the demagnified secondary image, most of the amount of energy of the primary ray 703, which originated in the sun 701, is refracted by the outer air-glass surface 709, according to Snell's law, where part of it transfers through the intermediate partially reflective medium 710. Similar to what has been described earlier, the amount of the transmitted light 711 (that passes the partially reflective medium 710) is dependent by the reflectivity efficiency of the medium 710. In most cases the light that is originated in a strong illumination source 701, in particular from the sun, will be totally unpolarized. Therefore, the incident light 703, that light that transfers through the intermediate medium 711 and the light that is refracted according to Snell's law 712 will be unpolarized (under the assumption that the intermediate medium 710 is not polarizing the light). According to what has been assumed earlier, the incident angle of the beam 703 is nearly θB, and therefore, according to Snells law and taking into consideration that the refractive indexes before and after the element are air, the transmitted light 712, that passes the Mangin mirror 702, has an incident angle of nearly θB. Consequently, according to Fresnel equations, all the TM polarization component will be refracted by the internal glass-air interface 713 and will be part of the transmitted light 712. To this end, the portion of light 714 that is reflected back on the inner glass-air interface 713 has to be TE, since all the TM coefficient has been refracted to the air by the glass-air interlayer 713 and is contained in the unpolarized transmitted ray 712. The portion of light 715 that is reflected by the intermediate partially reflective medium 710 is also TE, where its amount of energy is defined by the reflectivity efficiency of the TE component in the intermediate medium 710. The light that meets the intermediate medium 710 is reflected by a concave surface, and therefore positive optical power results in magnification is occurring, Next, the portion of light 716 that is refracted by the glass-air interlayer 713 will be directed to the observer's eye 708. Eventually, the ghost image 707 resulted by the straylight 716 will be a blurry magnified and distorted image of the sun 701, directed along the continuation 717 of the straylight 716.

### SUMMARY OF THE INVENTION

The following is a simplified summary providing an initial understanding of the invention. The summary does not necessarily identify key elements nor limit the scope of the invention, but merely serves as an introduction to the following description.

According to a first aspect of the invention there is provided a layered structure for manipulating optical polarization for a head-up display application comprising a Picture Generating Unit “PGU”, the structure adapted to receive polarized light oriented along a Transverse Magnetic “TM” polarization direction, from said PGU, said structure comprising: a first layer comprising a plano-convex lens, wherein the angle between the incidence angle and the optical axis of the plano-convex lens satisfies a Brewster angle; a first polarization manipulating layer adjoining said first layer and adapted to transform the polarization state of said polarized light; an optical partial reflective filter that is designed according to the polarization and reflectivity requirements; and a plano-concave lens, conjugated to the first plano-convex lens.

According to an embodiment, the filter may have a significantly higher reflection efficiency for Transverse Electric “TE” polarization relative to a negligibly low efficiency for TM polarization.

According to an embodiment the filter may be designed for an incident angle that satisfies the Brewster angle, taking into consideration the Snell's law.

According to an embodiment the structure may further comprise a first polarization manipulating layer oriented about 45° relative to the polarization direction of the incident light TM.

According to an embodiment the structure may comprise a second polarization manipulating layer adjoining said plano-concave lens and adapted to transform the polarization state of polarized light transmitted through said optical filter.

According to an embodiment the first and second polarization manipulating layers may each comprise a first half-wave retarder plate and a second half-wave retarder plate.

According to an embodiment the orientation of the first half-wave retarder plate and the second half-wave retarder plate may be about orthogonal to each other.

According to an embodiment the orientation of the second half-wave retarder plate may be adapted to decrease any portion of TE polarization caused by birefringence effect in the medium between the two wave-retarders.

According to an embodiment plano-convex lens and the plano-concave lens may comprise an index matching material.

According to an embodiment the plano-convex lens and the plano-concave lens planar surfaces may be replaced with curved surfaces.

According to an embodiment the two curved surfaces may comprise a curved transparent surface with no optical power.

According to an embodiment the index-matching material layer may comprise an index-matching adhesive.

According to an embodiment the convex and the concave surfaces may be implemented in the form of a thin element, using the Multi-Layered-Thin-Combiner structure.

A second aspect of the invention provides a windscreen for manipulating optical polarization in a head display system, the head-up display system comprising a projection light source, the windscreen comprising at least two transparent substrates and the structure of any of the embodiments sandwiched therebetween.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

### In the Accompanying Drawings:

FIGS. 1A and 1B are diagrams illustrating a Mangin mirror, according to the prior art;

FIG. 2 is a graph showing the reflectance for a single thin layer of Titanium Oxide located between two glass substrates, according to the prior art;

FIG. 3 is a graph showing the reflectance for an optical filter, according to the prior art;

FIG. 4A is a diagram illustrating demagnified ghost imaging created by stray light that is reflected by the convex side of the Mangin mirror, according to the prior art;

FIG. 4B is a diagram showing the detailed ray-tracing, according to the prior art;

FIG. 5 is a detailed diagram illustrating the rays as they pass through the Mangin mirror, according to the prior art;

FIG. 6 is a graph representing the amount of power that exists in the secondary (ghost) image along with the TE and TM polarizations and an average between them, versus the incident angle in the range 0-90°, according to the prior art;

FIG. 7A is a diagram illustrating the magnified ghost imaging created by stray light, that is reflected by the concave side of the Mangin mirror, according to the prior art;

FIG. 7B is a diagram showing the detailed ray-tracing, according to the prior art;

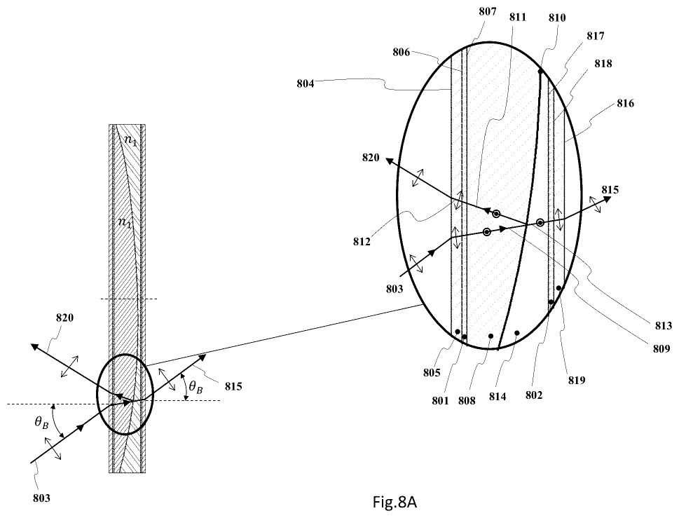

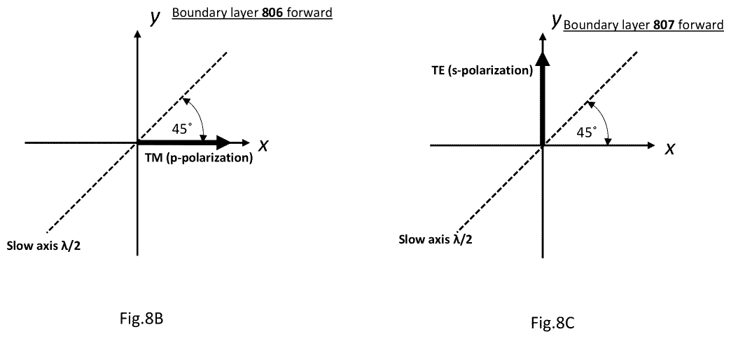

FIG. 8A to 8E illustrates an optical arrangement according to embodiments of the invention, specifying the TE and TM polarizations' directions, according to some embodiments of the present invention;

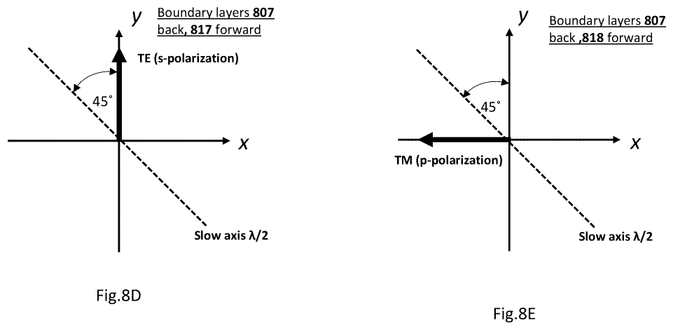

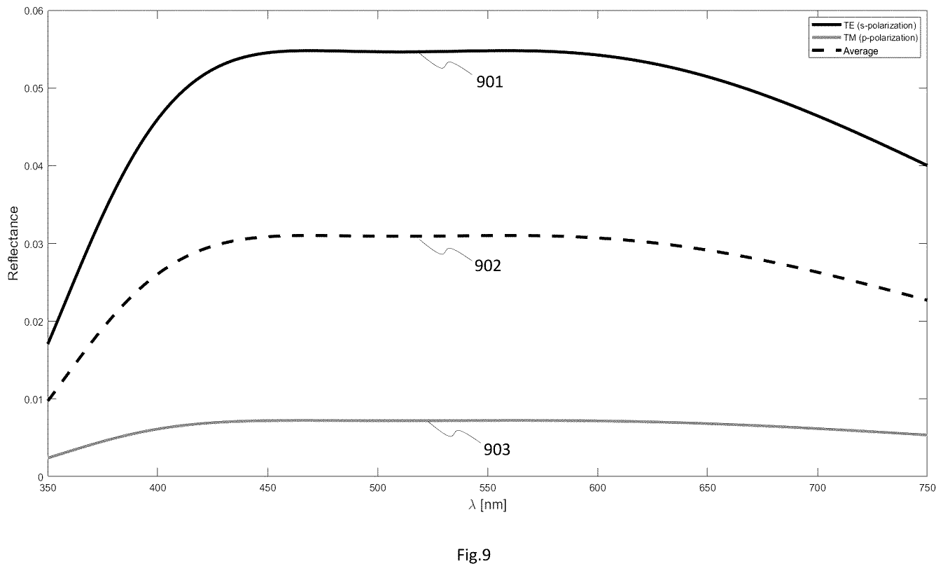

FIG. 9 is a reflectance graph produced by embodiments of the present invention;

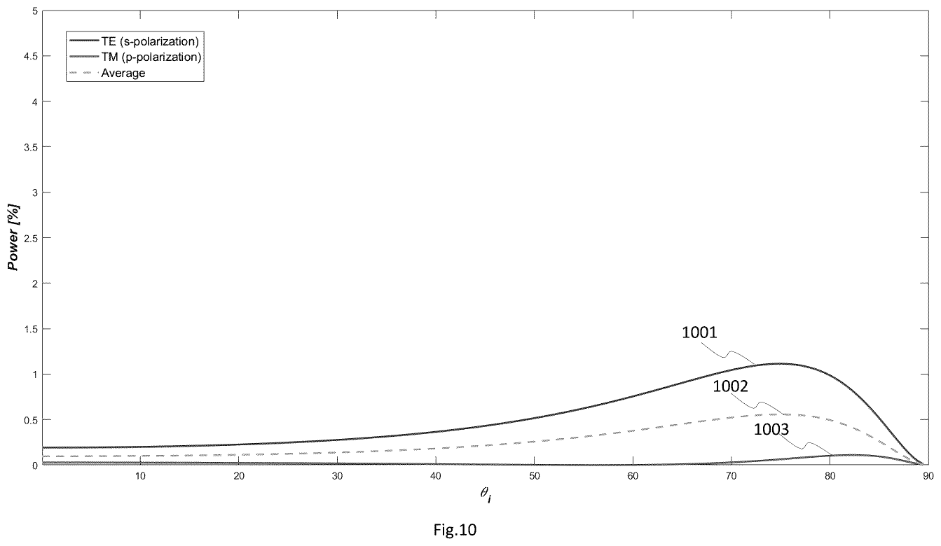

FIG. 10 is a reflectance graph produced by the ghost images according to embodiments of the present invention;

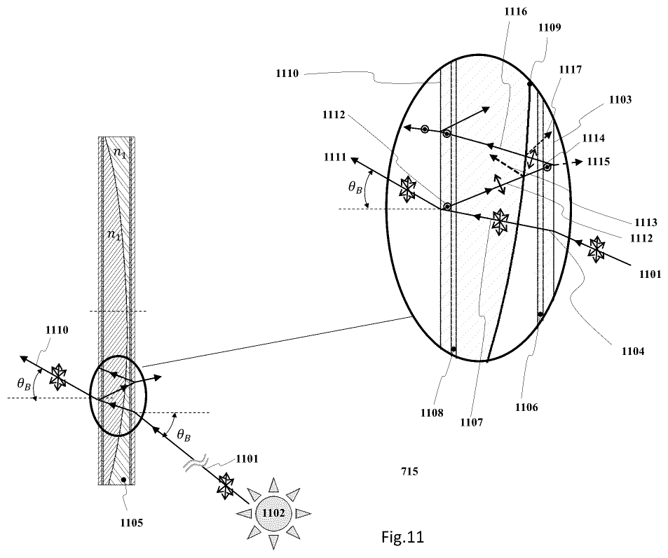

FIG. 11 illustrates an optical arrangement according to embodiments of the invention, where the magnified ghost image elimination is described;

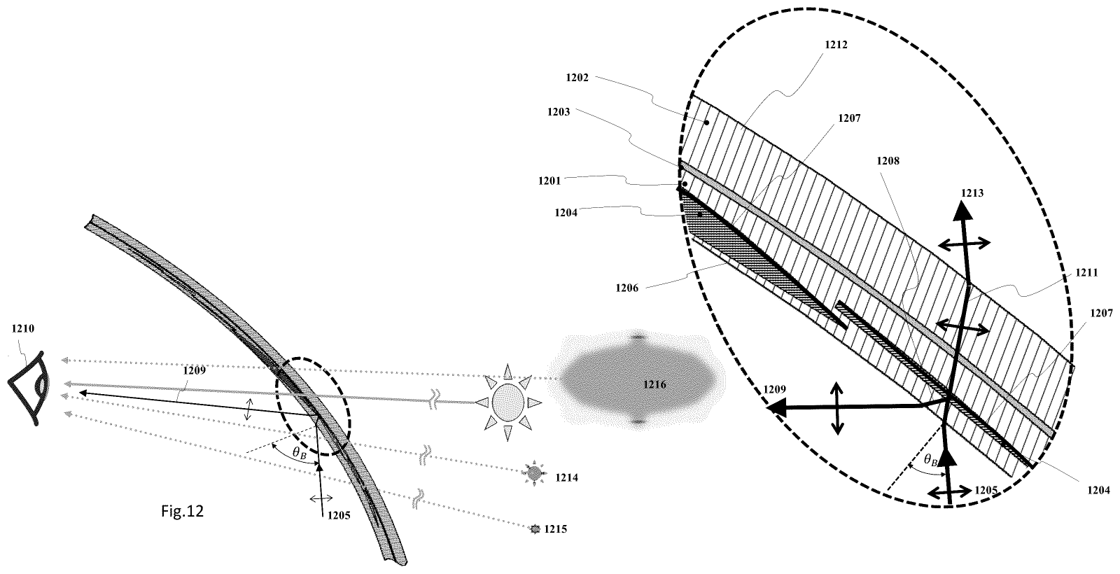

FIG. 12 illustrates ghost images being created due to the Multi-Layered-Thin-Combiner that is integrated in a typical windscreen, according to the prior art; and

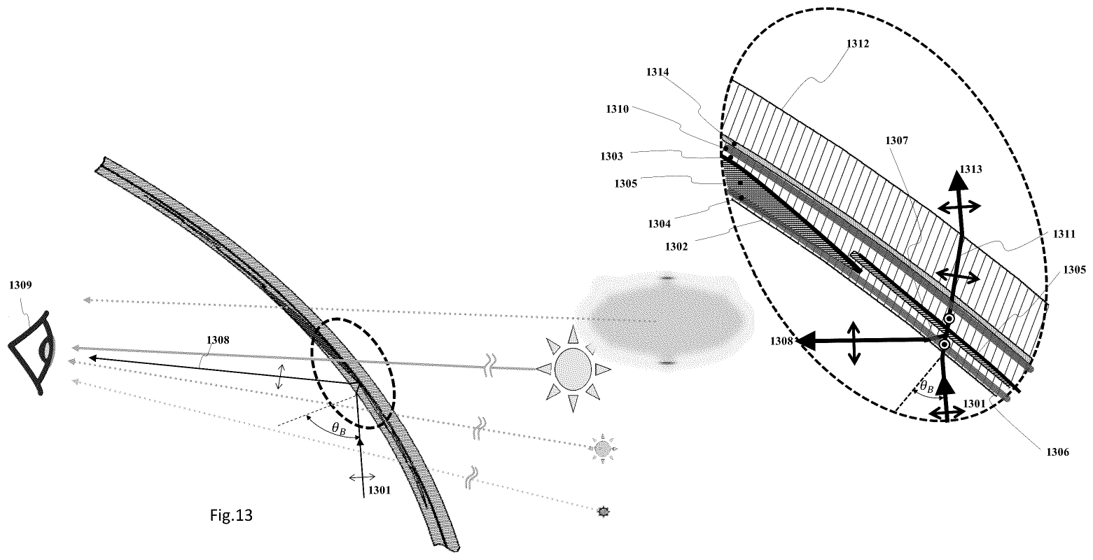

FIG. 13 illustrates the reduction of ghost images due to the Multi-Layered-Thin-Combiner that is integrated in windscreens using embodiments of the present invention.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention, With specific reference to the drawings, it is stressed that the particulars shown are by way of example and for purposes of illustrative discussion of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units may be at least partially implemented by a computer processor.

### The Two-Wave Retarders Method

The use of a TM (p polarization) direction of the incident light, tilted according to the Brewster angle, is greatly beneficial for the HUD system, since it enables to eliminate ghost images) from the air-glass interfaces (generated in the PGU); in particular, in a car's HUD the interior geometry supports the location of the PGU system at an angle of 55°-60° relative to the normal of the combiner (as mentioned before, the Brewster angle is approximately 570 for glass). However, as can be seen in FIG. 2 and FIG. 3, the reflectance efficiency corresponding to TM is relatively poor, on the one hand, whilst on the other hand, the average reflectivity is relatively high (due to the existence of a strong reflectance efficiency in the TE polarization direction). As a result, significant demagnified secondary images of strong illumination sources (e.g., the sun) may emerge, in particular, for large angles. Additionally, as mentioned before, additional strong illumination sources that are nearly aligned with the central ray that creates the HMB (i.e., the line of sight of the observer) result in a magnified distorted ghost image that might blind the observer. To this end, an elegant optical configuration is proposed to enhance the reflectance efficiency of TM polarized light on one hand, while eliminating any type of ghost images that might be created due to the existence of the partially reflective interlayer that provides optical power.

Wave-retarders, in the form of a thin transparent polymer sheet, are commonly used for a variety of applications, their cost is relatively low, and they are exceptionally durable (e.g., polymer retarder film that can be found in Edmund optics).

The optical arrangement presented in FIGS. 8A-E, contains two half-wavelength wave-retarders 801, 802. The two elements are located before and after the Mangin mirror and sandwiched between the optical element and thin transparent faceplates (e.g., thin glass sheets). Locating each wave-retarder in a specific orientation, relative to the polarization's direction of the light, enables to decrease the existence of ghost images to a minimum, whilst supporting almost the same amount of reflectivity as was given in the previous example (5-6% of reflectivity).

From the PGU reflectance side, similar to the original concept (presented in FIG. 1A), according to FIG. 8A, an incident TM light 803 meets the outer air-glass interface 708 at the Brewster angle θ_{B}. The light is refracted with negligible reflection and penetrates a thin glass plate 805 that is attached to a wave-retarder film 801. At the boundary layers 806 and 807 (between the inner glass plate 805 and the inner wave-retarder 801 and between the inner wave-retarder and the plano-convex lens 808) an index matching adhesive may be used. As illustrated in FIG. 8B, the slow axis of the inner wave-retarder film 708 is rotated at substantially 45° with respect to the direction of the incident light. Consequently, the polarization of the traveling light after the inner wave-retarder 801 rotates by substantially 90° and it is now TE (s-polarized) 809. The light that travels inside the plano-convex element 808, which is now TE, meets the intermediate partially reflective medium 810. Next, a portion of the TE light 811 is reflected back, modulated by the concave shape (similarly to the previous case). The reflection from surface 810 is due to the stronger part of the filter (every multi-layered filter at an angle will always be more efficient for TE then TM). The TE reflected light 811 impinges once again the inner wave-retarder 801 that is oriented (in its slow axis) to substantially 45° with respect to the TE polarization direction [see FIG. 8B]. As a result, the light that transmits through the glass-plate 812, and refracted at surface 804, is now TM polarized. Therefore, due to the fulfillment of the Brewster angle, the portion of the light that is reflected at the refraction surface 804 may be again negligible.

The rest of the light 813 that is transmitted through the intermediate medium 810 propagates in the plano-concave element 814, where it is oriented in the TE polarization direction and meets the outer wave-retarder film 802. The slow axis of the outer wave-retarder 802 is also oriented at substantially 45° relative to the polarization direction of the transmitted ray 813 [FIG. 8C]; in other words, the two wave-retarders are substantially orthogonal to each other. As a result, the light that transmits through the outer glass plate and is refracted at the Brewster angle 815 rotates by substantially 90° is now TM polarized [see FIGS. 8D and 8E], and therefore, reflections at the outer surface 816 are also negligible. Similar to the inner wave-retarder 801, the two surfaces 817, 818 of the outer wave-retarder may also be bonded with an index matching adhesive to the outer thin glass 819.

The structure of the two-perpendicular wave-retarders, λ/2, may provide the ability, on the one hand, to orient the light that meets the partially reflective intermediate layer along with the TE polarization, whilst preventing any existence of stray light that is reflected from any surface besides the intermediate layer, and thus, may discard all the ghost images from the transmitter side. Rotating the light polarization that meets the partially reflective medium to be TE polarization opens up a new realm of possibilities to a tilted light (particularly in a case where the incident light is directed at the Brewster angle) since the efficiency of any partially reflective medium may now be dramatically higher.

As a result of the double wave-retarder configuration, the present invention provides a filter that may be designed to reflect only the TE polarization direction.

In FIG. 9 the reflectance of an example of such a filter is presented, where the reflectance corresponding to TE polarization 901 is approximately 5.5%, whilst the reflectance corresponding to TM polarization 903 is less than approximately 0.75%. The efficiency of this filter on the one hand is almost similar to the reflectance of the filter presented in FIG. 3 (the reflectance corresponding to the TM polarization there is approximately 6%), but the average reflectance 902 is approximately 3%. In other words, due to the use of the two-perpendicular wave-retarders of the present invention one can achieve almost the same reflectance efficiency, whilst the average decreases from approximately 12% to approximately 3%. In this case the filter will be almost indistinguishable and the existence of ghost images from outside (e.g., the sun in different positions) may also decrease dramatically.

To estimate the relative amount of power at the secondary demagnified ghost image, according to the filter of the present invention, the present inventors repeated using the above-mentioned analysis (similarly to what has been shown in FIGS. 5, 6). In FIG. 10 the result of a numerical calculation of the power of the secondary image with respect to TE and TM polarization components 1001 and 1003, and the average 1002 between them. According to the results, one can realize that the maximal average power at the peak is approximately 0.55%, where the angle of the incident ray is around 75°. Additionally, between 0-50° the average power is less than 0.25%. In other words, according to the present invention, that enables the usage of the filter presented in FIG. 8A, the power of the secondary image decreases from approximately 1.6% at the peak to less than around 0.6%, whilst the reflectance efficiency of the filter remains almost the same.

FIG. 11 depicts the internal ray tracing that might create the magnified ghost image of strong illumination sources, exists in the same optical arrangement presented in FIGS. 8A-8E). Any unpolarized ray 1101 originated by a strong illumination source 1102, is refracted by the outer air-glass interface 1103, according to Snell's law. The light that penetrates to the medium 1104 of the Mangin mirror 1105, meets the first wave retarder λ/2 1106 that is oriented in 45° with respect to TM polarization direction (as mentioned above). The beam 1107 that transfers through the wave retarder 1106 is not being affected by it and remains unpolarized, as well as after the second wave retarder λ/2 1108 (that is also oriented in 45° with respect to TM polarization direction). Nevertheless, following the filter that has presented earlier, the intermediate layer 1109 has a relatively significant attenuation in the TE polarization component, where its TM is negligible. For example, according to filter presented in FIG. 8A, the transmission of the light 1107 right after the filter 1109 consists of 94% in the TE component and 99.5% in the TM component. Consequently, without taking into consideration minor reflections created by the outer air-glass surface 1103 and the inner glass-air surface 1110, and by neglecting the minor absorption of the medium, the average transmission of the overall transferred ray 1111 will be 96.75%. In other words, in this case the overall attenuation of the outside scenery will be approximately 5%. The portion of light 1112 that is reflected by the glass-air interlayer 1110 consists only on TE polarization; i.e., following to what has mentioned before, according to Fresnel equations, in the case of internal reflection, because the beam 1111 is nearly fulfills the Brewster angle it contains the whole TM polarization component, and therefore the internal reflected light 1112 will be pure TE. As the light transfers through the second wave retarder 1108 its polarization orientation rotates in an angle of 90° 1112 and is now TM (because the slow axis of the second wave retarder 1108 is oriented in 45° relatively to its original polarization direction). Next, because the TM reflection efficiency of the filter 1109 is nearly zero, the amount of light that will be reflected 1113 from the concave side of the intermediate filter 1109 will be negligible. The polarization orientation of the transmitted beam 1114 that transfer the first wave retarder 1106 is now again pure TE and according to Snell's law the portion of light that is refracted 1115 through the outer air-glass surface 1103 fulfills the Brewster angle (taking into consideration that the inner and outer glass surface, 1110 and 1103, respectively, are parallel). Therefore, most of the energy will be internally reflected in the medium and will pass the wave first retarder 1106 one more time. The polarization orientation of the transferred light 1116 is rotated again and is now TM. Similarly to what has been shown earlier the TM polarization has a negligible reflection 1117 from the convex surface of the intermediate interlayer 1109. Eventually, the light will be bounced from the outer air-glass interlayer 1103 and the internal glass-air interlayer 1110, similarly to what happens in any regular window. In summary, the same optical arrangement, consists of two perpendicular wave retarders oriented in 45° relatively to TM polarization direction, combined with a filter with nearly zero TM reflection efficiency that is applied in the intermediate layer, provides the ability not only to eliminate the demagnified ghost images but also to eliminate the magnified ghost images, as well as providing a much efficient optical filter that reflects the TE polarization orientation.

### Multi-Layered-Thin-Combiner

To this end, named the Multi-Layered-Thin-Combiner (MLTC), provides the ability to implement a thin transparent optical element that may be laminated between the windscreen's layers, whilst providing optical power (i.e., focal distance) to the light that is reflected from the windscreen without affecting the see-through channel.

Since the MLTC consists of multiple segments, each of which with optical power, it behaves as a stack of multiple fractions of thin Mangin mirrors on which a single large aperture consists. Therefore, ghost images of strong illumination sources from outside might be created, resulting in visual artifacts and glare at the see-through channel (see FIG. 12).

The optical schemes for both a Mangin mirror and the MLTC segments are integrated in a medium that has planar surfaces (surface 804 and surface 816 in FIG. 8A). In a more general case those surfaces may be curved, where the medium in between has a uniform thickness (i.e., a meniscus element with zero optical power).

In most typical windscreen, for example in a car, two sheets of glass (an inner layer 1201, and an outer layer 1202) are cemented by a polymer 1203 made of polyvinyl butyral (PVB), The MLTC segments 1204 may be laminated inside the inner glass layer 1201; or the inner layer may be replaced by an MLTC as a stack that may be employed as a new inner layer. Similar to the Mangin based element, the reflectance of which is presented in FIG. 1A and in FIG. 8A, a TM (p-polarized light) 1205, originating from a PGU, meets the inner surface 1206 (that can be related to the inner glass layer 1201 or to the MLTC 1204 as a standalone component) at the Brewster angle. The light is refracted, penetrates to the element, and meets the MLTC segments 1204, on which the partially reflective coatings 1207 are deposited. Similar to the previous concept, a portion of the light 1208 is reflected back, and will be refracted as ray 1209 at an angle close to the Brewster angle. This light 1209 will be perceived by the observer 1210. The rest of the light 1211 transmits through the partially reflective coating 1207, through the PVB 1203, and the outer glass layer 1202. Finally, it is refracted (at surface 1212) outside to the air 1213, where it is TM polarized (due to the Brewster angle in the air-glass interface, similarly to the previous cases, the reflection from the boundary layer 1212 is negligible).

According to the above-mentioned scheme, the light that meets the MLTC partially reflective segments 1207 is TM polarized. As a result, the reflectance efficiency is relatively poor and is similar to the scheme presented in FIG. 1A. Additionally, according to what was mentioned previously, due to the relatively strong average reflectivity (e.g., 12%) multiple ghost images (for example 1214, 1215, and 1216) of strong illumination sources may be perceivable by the observer, in particular, those which are directed in large angles relative to the surface normal.

According to embodiments of the present invention, in FIG. 11, the TM (p-polarized) light (originated at the PGU) 1301 meets the inner surface 1302 (at the Brewster angle), refracts (according to Snell's law), and penetrates to the inner layer 1303. A λ/2 wave retarder 1304 is placed between the inner surface 1302 and the MLTC segments 1305, where its slow axis is oriented with 45° with respect to the TM polarization direction, the polarization of the light is rotated by 90° and it is now TE (s-polarized) 1306. Consequently, the portion of the light that meets the partially reflective MLTC segments 1305 is now TE polarized, Next, the light 1307 that is reflected back transmits through the inner wave-retarder 1304, its polarization orientation is rotated by substantially 90° (and it is now back to being TM polarized), refracts at surface 1302, and traced 1308 to the observer's eye 1309 (with a negligible secondary reflection). The portion of the light that passed through the partially reflective coating transmits through a second λ/2 wave-retarder 1310 (named the outer wave-retarder), where its slow axis is oriented by substantially 45° relative to the TE-polarization direction (and orthogonal to the slow axis of the inner wave retarder 1304). The transmitted light 1311 is rotated by substantially 90°, and it is back to being TM-polarized. Finally, it is refracted (at surface 1312) to the air 133, where it is TM-polarized (due to the Brewster angle in the air, the reflection from the boundary layer 1312 is negligible). Each of the inner and outer wave-retarders may be cemented to the glass (or to the PVB 1314) by an index matching medium.

The use of the two substantially orthogonal wave-retarders of the present invention provides the ability to exploit the larger reflection efficiency of the filter to TE-polarized light, whilst substantially eliminating secondary images of strong external illumination sources (located in large angles relative to the windscreen's normal) that are expected to be developed due to stray-light that will be reflected by the MLTC effective segments. By doing so, the present invention provides a thin element with optical power and an efficient reflectance, whilst the MLTC segments are almost indistinguishable, due to a low average reflectance (e.g., an average of about 3% according to the graph in FIG. 9). Additionally, the power of the secondary images of strong illumination sources is minimized (for example, maximal percentage of about 0.5 at an angle of about 75° according to FIG. 10).

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention.

1. A layered structure for manipulating optical polarization for a head-up display application comprising a Picture Generating Unit “PGU”, the structure adapted to receive polarized light oriented along a Transverse Magnetic “TM” polarization direction, from said PGU, said structure comprising:
a first layer comprising a plano-convex lens, wherein the angle between the incidence angle and the optical axis of the plano-convex lens satisfies a Brewster angle;
a first polarization manipulating layer adjoining said first layer and adapted to transform the polarization state of said polarized light;
an optical partial reflective filter adapted according to the polarization and reflectivity requirements; and
a plano-concave lens, conjugated to said first plano-convex lens.

2. The structure of claim 1, wherein said filter has a significantly higher reflection efficiency for Transverse Electric “TE” polarization relative to a negligibly low efficiency for TM polarization.

3. The structure of claim 2, wherein said filter is designed for an incident angle that satisfies the Brewster angle, taking into consideration Snell's law.

4. The structure of claim 1, further comprising a first polarization manipulating layer oriented about 45° relative to the polarization direction of the incident TM light.

5. The structure of claim 1, further comprising a second polarization manipulating layer adjoining said plano-concave lens and adapted to transform the polarization state of polarized light transmitted through said optical filter.

6. The structure of claim 1, wherein said first and second polarization manipulating layers each comprise a first half-wave retarder plate and a second half-wave retarder plate.

7. The structure of claim 1 wherein the orientation of the said half-wave retarder plate and said second half-wave retarder plate is about orthogonal to each other.

8. The structure of claim 1 wherein the orientation of said second half-wave retarder plate is adapted to decrease any portion of TE polarization caused by birefringence effect in said medium between said two wave-retarders.

9. The structure of claim 1, wherein said plano-convex lens and said plano-concave lens comprises an index matching material.

10. The structure of claim 1, wherein said plano-convex lens and said plano-concave lens, wherein the planar surfaces are replaced with curved surfaces.

11. The structure of claim 10, wherein said two curved surfaces comprises a curved transparent surface with no optical power.

12. The structure of any of claim 9, wherein said index-matching material layer comprises an index-matching adhesive.

13. The structure of claim 1, where said convex and said concave surfaces are implemented in a form of a thin element, using said Multi-Layered-Thin-Combiner structure.

14. A windscreen for manipulating optical polarization in a head display system, the head-up display system comprising a projection light source, the windscreen comprising at least two transparent substrates and the structure of claim 1 sandwiched therebetween.
